(19) United States
(12) Patent Application Publication
(10) Pub. No.: US 2021/0083871 A1
(43) Pub. Date: Mar. 18, 2021

(54) METHOD AND DEVICE FOR IMPLEMENTATION OF SAFE TRANSACTIONS IN BLOCKCHAIN INFRASTRUCTURE

(71) Applicant: Aleksey Sergeevich Smirnov, Reutov (RU)

(72) Inventor: Aleksey Sergeevich Smirnov, Reutov (RU)

(73) Assignee: Aleksey Sergeevich Smirnov, Reutov (RU)

(21) Appl. No.: 16/309,454

(22) PCT Filed: Apr. 11, 2018
(86) PCT No.: PCT/RU2018/000228

§ 371 Date: Dec. 13, 2018

(51) Int. Cl. H04L 9/08; H04L 9/06; H04L 29/06

(52) U.S. Cl. CPC H04L 9/0894; H04L 9/0833; H04L 2209/38; H04L 63/0861; H04L 9/0637

(57) ABSTRACT

The proclaimed solution is related to the method of implementation of transactions in blockchain infrastructure with the protected device for safe cryptocurrency storage. This solution is directed to resolving the technical problem, which presents elimination of the existing disadvantages and offers the extended by functions hardware wallet for the cryptocurrency storage, which has an improved protection degree from the unauthorized access to the identification information of the user's account and its use for the implementation of transactions in the blockchain infrastructure.

### TECHNICAL FIELD

The proclaimed solution is related to the method of implementation of transactions in blockchain infrastructure with the protected device for safe cryptocurrency storage.

### BACKGROUND

With the development of blockchain infrastructure for the implementation of transactions with various types of cryptocurrency, the most critical aspect pertains to the provision of safe money storage on the wallets, almost all of which are the software application and are under the risk of software hacking.

The alternative to the software wallets is the hardware wallets, which provide a cryptocurrency storage on the external device having no direct connection to the Internet networks, so it improves the safety of money storage. However, these devices have disadvantages as well, in particular:
Necessity of updating the firmware and the device software, which may entail an unauthorized access to the money stored. Not all of the wallet firmware has open source codes, so it does not allow to reliably confirm the fact that in case of having access to the Internet the information from the wallet would not be transmitted to an external resource without any user's consent.
Necessity of using a specialized software for the interaction with the wallet, so it can also be used for stealing money from the user's cryptocurrency account. The absence of the transparent scheme of private keys generation in order to confirm the transactions.
Due to the fact that the hardware wallet is a specialized device, the technical scheme of its components' structure is the manufacturer's trade secret, and the user has no opportunity to verify its reliability and safety.

One of the solutions of the existing problems related to hardware wallets is the method of generating private keys for the transaction signatures in the blockchain infrastructure and on the device itself, without any access and connection to the Internet network, so it provides the storage of the required identification data of the account and the data of transaction authentication on the external device (application CN104463001A, 25.03.2015).

But this solution as well does not provide the proper degree of protection, since the information is stored in the single device section and is tied to the single type of the master keys for the data generation of the transaction authentication, so it reduces the functionality of this solution for the various types of cryptocurrencies.

### SUMMARY

This solution is directed to resolving the technical problem, which presents elimination of the existing disadvantages and offers the extended by functions hardware wallet for the cryptocurrency storage, which has an improved protection degree from the unauthorized access to the identification information of the user's account and its use for the implementation of transactions in the blockchain infrastructure.

Technical effect of the proclaimed solution coincides with the technical problem being resolved.

In one example of preferred embodiment solution related to a method of performing transactions in a blockchain infrastructure by using a protected device for storing cryptocurrency, comprising the steps of:

forming a secure area on the cryptocurrency storage device for storing private keys or a master key for the transaction authentication and an open area for the primary transaction storing, though the secure area comprises a software module for performing the transaction signature procedure;

generating a primary transaction file and saving it to the designated open area of the specified device;

activating the program module in order to confirm the transaction and generate, with using the master key, at least one private key for the primary transaction authentication;

generating a certified transaction id in the secure area of the specified device by adding the private key data to the primary transaction;

generating a unique id for the private key and for the data of the primary transaction, the unique id is added to the primary transaction, thereby this transaction is considered certified and is ready to be forwarded to the blockchain account saving the id of the certified transaction to the designated open area of the device;

saving the certified transaction to the designated open area of the device;

establishing a connection between the open area of the device and the data network with access to the blockchain infrastructure;

performing a transaction by transferring a certified transaction to the blockchain infrastructure.

In another example of embodiment solution related to protected device for performing transactions in the blockchain infrastructure, comprising a microcontroller and a memory module, wherein the memory module comprises

an encrypted area containing a master key and a software module for performing the transaction confirmation procedure by generating private keys based on the master key;

an open area for storing transaction IDs, wherein

the software module is designed in order to authenticate transactions using a private key in the secure area and transfer the certified transaction to the open area of the device for the further transmission to the blockchain infrastructure through the data network.

### DRAWINGS

FIG. 1 illustrates the scheme of the claimed device.

FIG. 2 illustrates the scheme of the device's secure area.

FIG. 3 illustrates the transaction's flow chart.

FIG. 4 illustrates the common scheme for implementation of the claimed solution.

### DETAILED DESCRIPTION OF THE INVENTION

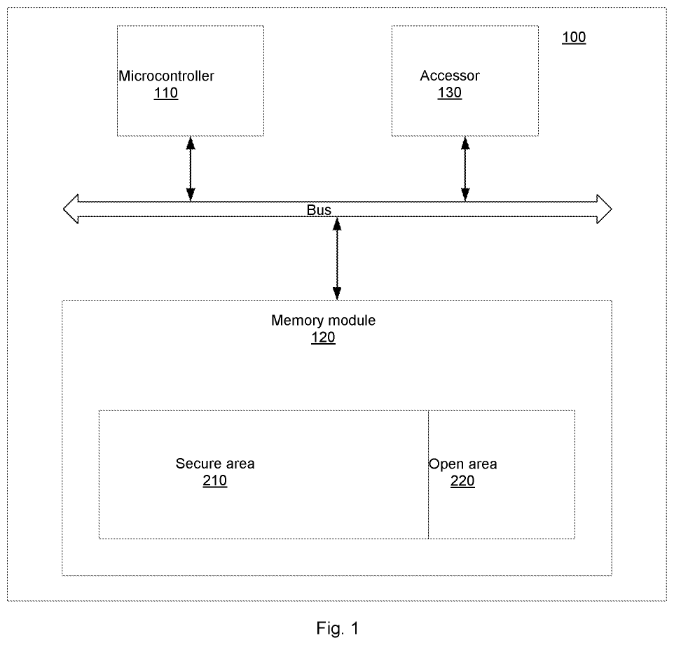

FIG. 1 represents the common scheme of the claimed device (100). In general, the device (100) can be implemented as a USB flash drive, an external hard disk or a memory card. The device (100) comprises a microcontroller (110) providing the required computational processing, a memory module (120) for storing the required information, and an accessor (130) providing access control to the device (100).

The memory module (120) comprises labeled areas, in particular, a protected (121) and an open area (122).

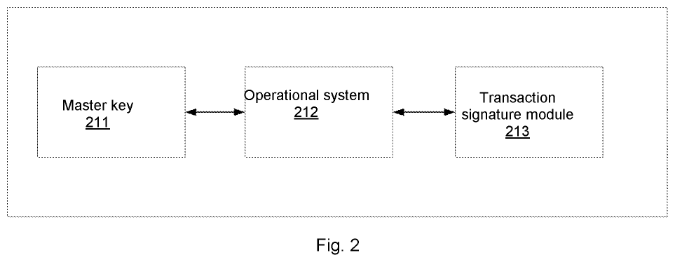

As shown in FIG. 2, the secure area (121) contains an installed operating system (212), for example, Linux OS, which is elaborated to exclude access to the Internet, a master key (211) for generating private keys for signing transactions, and a transaction authentication module applying the generated private keys (213).

The master key file (211) is protected by the hardware encryption and may be represented, for example, as a mnemonic phrase generator (seed) to form a unique sequence of words or characters used to generate hash functions for private keys. The master key (211) may be used to generate keys for the various types of cryptocurrency protocol, for example, Bitcoin, Etherium, Zcash, LiteCoin, BitcoinCash, etc.

The transaction authentication module (213) is designed to sign the generated private key files of primary (raw) transactions that are stored in the open area (220).

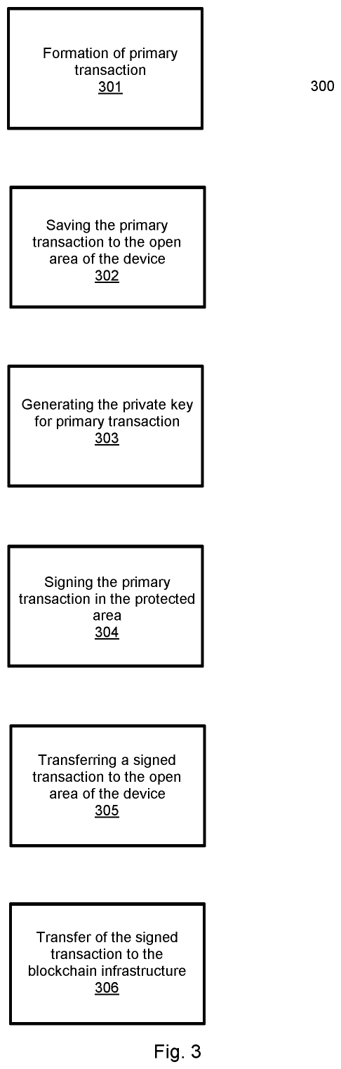

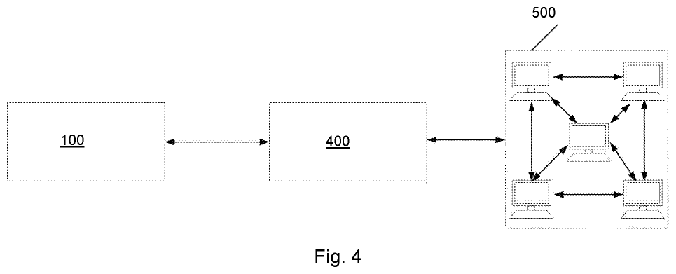

FIG. 3-FIG. 4 represent a method for executing a transaction (300) and an interaction structure for implementing it by using the device claimed (100). At the first stage (301), the user of the device (100) creates a primary transaction (raw transaction), this transaction contains information about the transfer, namely, the type of the cryptocurrency, the transfer amount, the addressee and the addressant and other technical information corresponding to the specific blockchain protocol. This information is public and can be obtained from any node of the blockchain network (500).

Subsequently, the file with the primary transaction is transferred to the open area (220) of the wallet device (step 302). After saving the primary transaction file in the open area of the device (220), the user activates the generation of the private key (303). Generation of private keys is performed by downloading the OS (212) on the device (100) in a protected mode. In this mode, the generation of private keys or a master key (211), from which you can then retrieve the new private keys by using a hash function corresponding to the protocol of the blockchain file of the primary transaction file, may be performed.

After the private key (304) is generated for the primary transaction file that is placed in the secure area, while the keys are generated (210), the data with the private key and the primary transaction are transferred to the transaction authentication module (213), which is signing the primary transaction. During the signature procedure, the authenticated transaction ID is generated in the secure area (210) by inputting the private key data in the primary transaction.

By virtue of the generated private key and the primary transaction data, a unique digital signature is generated according to the network algorithm of the blockchain (500) network and, in particular, according to the corresponding blockchain protocol, under which the transaction is performed. Creation of this signature is possible only by the owner of the private key. Verification of the signature validity in the future is carried out by the node of the blockchain network (500).

As the computing device (400), for example, a personal computer, a laptop, a tablet, a smartphone or a portable game console may be used. The connection of the device (100) to the Internet can be performed using various types of communication and/or connection.

The device (100), when configured in the form of a standard USB-flash drive, is connected via a standard USB connector or an OTG-USB cable when using a mobile device (smartphone, tablet) as a device with Internet access. After the transaction (305) is signed using the generated private key, the signed file with the transaction ID is transferred to the open area (220). After that, the device (100) is connected to an external computing device (400) with access to the Internet, using which the network protocol (500) interacts with the blockchain protocol of the network, namely, the transfer of the signed file with the transaction data from the open area (220) to the blockchain protocol of the respective cryptocurrency. The device (100) can be manufactured with various types of built-in connectors (USB, USB-C, micro-USB, Lightning, etc.) or contain a removable connector for connecting to various types of external devices (400).

The device (100) may also be designed with a wireless communication module for communicating with external devices via a wireless data link, for example, Wi-Fi, GSM (GPRS, LTE), etc.

The device (100) may be additionally designed with various protection facilities, for example, a code access or of biometric type. As the code access facility, a pinpad or a keyboard may be used in order to input an access code for accessing the information stored on the device (100) (for example, Apricorn Aegis Secure Key USB Encrypted Flash Drive). As the facility of biometric protection, a fingerprint scanner, an eye retina scanner, and a voice recognition module can be used.

The presented materials disclose the main preferred examples of implementation of the claimed solution and should not be interpreted as limiting any other, particular forms of implementation, understandable to a person having ordinary skill in the art.

1. A method of performing transactions in a blockchain network with using a protected device for storing cryptocurrencies, comprising following steps:
forming a secure area on the cryptocurrency storage device for storing a master key for authenticating transactions and an open area for storing primary transactions, wherein the secure area comprises a program module for performing a transaction signature procedure;
generating a primary transaction file and saving it to the designated open area of the protected device;
activating the program module in order to confirm the transaction and generate, with using the master key, at least one private key for the primary transaction authentication;
generating a certified transaction ID in the secure area of the protected device by adding the private key data to the primary transaction;
generating a unique ID of the certified transaction in the secure area of the protected device by using private key data and primary transaction data;
saving the ID of the certified transaction to the open area of the protected device;
establishing a connection between the open area of the protected device and a data transmission network with access to the blockchain network;
performing a transaction by transferring the certified transaction to the blockchain network.

2. The method of claim 1, wherein data exchanging between the protected device and the blockchain network is performed by connecting the protected device with a computing device with access to the Internet.

3. The method of claim 2, wherein connection with the computing device is performed by means of a hardwired or a wireless connection.

4. The method of claim 3, wherein hardwired connection is performed by using interface, which represents: USB, micro-USB, USB-C or Lightning.

5. The method of claim 3, wherein wireless connection is choosing from Wi-Fi, Wi-Fi Direct, Bluetooth, BLE or NFC.

6. A protected device for performing transactions in the blockchain network comprising a microcontroller and a memory module, wherein the memory module comprises an encrypted area containing a master key and a software module for performing the transaction confirmation procedure by generating private keys based on the master key;
an open area for storing transaction IDs;
wherein the software module is designed with a function to authenticate transactions using a private key in the secure area and transfer the certified transaction to the open area of the device for further transmission to the blockchain infrastructure through the data transmission network.

7. The device of claim 6, wherein represents a USB flash drive.

8. The device of claim 6, wherein access to the device is performed through an input of an identification information.

9. The device of claim 8, wherein input of the identification information is performed by using a keyboard, a pin-pad, or biometric identification means.

10. The device of claim 9, wherein biometric identification means choosing from a fingerprint scanner, an eye retina scanner, or a voice recognition module.
